(19) United States
(12) Patent Application Publication
(10) Pub. No.: US 2026/0145056 A1
(43) Pub. Date: May 28, 2026

(54) Two-stage Switch Structure for Game Controller

(71) Applicant: YUN XIE, Shenzhen City (CN)

(72) Inventor: YUN XIE, Shenzhen City (CN)

(21) Appl. No.: 18/959,603

(22) Filed: Nov. 26, 2024

(51) Int. Cl. A63F 13/24

(52) U.S. Cl. CPC A63F 13/24

(57) ABSTRACT

A two-stage switch structure for a game controller includes a slider within a controller casing, with a toggle lever extending through a sliding hole on the shell's surface. The slider has a first switch, and the trigger button has a touch rod adapted to this switch. The controller casing houses a Hall sensor, while the trigger button includes a Hall magnet for sensor activation. The sliding hole is L-shaped, with first and second segments. Inside the shell are first and second magnets, and the slider has third and fourth magnets. When the toggle lever is in the first segment, the magnets align to activate the first switch, blocking the trigger button's movement. When in the second segment, the magnets separate, triggering a toggle switch that activates the Hall sensor upon pressing the trigger button, precisely allowing the Hall magnet to activate the sensor and enabling accurate control.

### FIELD OF THE INVENTION

The present invention pertains to the technical field of game controllers, specifically to a two-stage switch structure for a game controller.

### BACKGROUND OF THE INVENTION

Currently, trigger buttons on game controllers available in the market primarily feature two modes: (A) pure linear mode and (B) pure conductive rubber or mechanical button switch mode. Both modes share the same control circuitry and internal structure, with the primary difference lying in the trigger mechanism. The linear mode trigger button has a long travel distance, while the mechanical button mode has a short travel distance. The pure linear mode uses a Hall magnet and a Hall sensor for activation, while the mechanical button mode relies on a micro switch for pressing activation. Existing game controllers generally use only one of these modes; to experience a different trigger button feel, users need to switch to a different controller. Therefore, users cannot switch between a linear feel and a mechanical button feel on a single game controller when switching between platforms.

The Chinese utility model patent with application number 202321598701.0 discloses a game controller with a trigger button that combines the Hall linear feel and mechanical button feel. This controller comprises a controller casing and a trigger. A sliding rail is set on the controller casing, with a slider mounted on it. The slider is equipped with a Hall sensor and a short-stroke switch, arranged at intervals along the sliding direction. The slider also has a toggle lever, while the trigger is provided with a matching seat with a Hall magnet and switch depression part. The slider slides along the rail, having a first sliding position that aligns the Hall sensor with the matching seat and a second sliding position aligning the short-stroke switch with the matching seat. As the slider moves from the first to the second position, the Hall sensor moves away from the matching seat on the trigger, especially from the Hall magnet. This setup allows the Hall sensor to move away from the Hall magnet when switching to a mechanical button feel.

However, the above-mentioned game controller has certain drawbacks. The toggle lever moves horizontally within a slot in the controller casing to control the slider on the rail, sliding it to either the first or second position, thereby switching the positions of the Hall sensor and short-stroke switch to toggle between the Hall linear and mechanical button feels. However, when the slider reaches the first or second position, it lacks a positioning mechanism to lock in place. The toggle lever can move freely within the slot, which may lead to accidental activation, causing incorrect positioning of the Hall sensor and short-stroke switch and affecting the operation of the game controller.

In view of this, the inventor proposes the following technical solution.

### SUMMARY OF THE INVENTION

The objective of this invention is to address the shortcomings of existing technology by providing a two-stage switch structure for a game controller.

To solve the above technical problems, this invention adopts the following technical solution: the two-stage switch structure for a game controller comprises a slider located inside the controller casing and adjacent to the trigger button. The controller casing has a sliding hole, with the toggle lever of the slider passing through the sliding hole and exposed on the surface of the controller casing. The slider is equipped with a first switch, and the trigger button has a corresponding touch rod that matches the first switch. The controller casing contains a Hall sensor/magnet, and the trigger button comprises a corresponding Hall magnet/sensor. The sliding hole is L-shaped, including a first sliding segment and a second sliding segment at an angle to each other. Inside the controller casing, a first and second magnet are positioned; the slider has third and fourth magnets matching the first and second magnets. When the toggle lever is in the first sliding segment, the third and fourth magnets are magnetically attracted to the first and second magnets, respectively, aligning the touch rod with the first switch and blocking the trigger button. When the toggle lever is in the second sliding segment, the third magnet is attracted to the second magnet, distancing the slider from the touch rod. The slider's movement activates a switch to trigger the Hall sensor, allowing the Hall magnet to activate the Hall sensor as the trigger button is pressed. Additionally, in this technical solution, the first sliding segment is inclined upward, and the first sliding segment is vertically distributed.

Further improvements include: an L-shaped sliding groove within the controller casing, with a sliding part on the inner side of the slider fitting into the groove. The first sliding segment is vertically distributed. The slider also has a fifth magnet, and the controller casing contains a sixth magnet matching the fifth. When the toggle lever moves to the second sliding segment, the third magnet is magnetically attracted to the second magnet, and the fifth magnet to the sixth magnet.

Further, the controller casing consists of a bottom shell and a top cover fixed together, with the sliding hole on the bottom shell.

Additionally, both the cross-sectional shapes of the sliding part and toggle lever are rectangular.

Furthermore, the toggle lever end is arc-shaped or pyramid-shaped, and the inner side of the slider has a third and fourth mounting slot embedding the third and fourth magnets.

Additionally, the inner perimeter of the sliding hole in the controller casing has a raised ring with a blocking part and a concave arc groove. The slider has a limiter that fits into the arc groove when the toggle lever is in the first sliding segment.

Additionally, a bracket within the controller casing provides a mounting position for the slider to slide, with the first and second magnets in mounting slots at the bottom of the mounting position. The inner side of the bracket has the sliding groove.

Additionally, the trigger button has an extension arm, and a Hall magnet is set at the end of this arm, with a Hall sensor inside the controller casing.

Furthermore, the inner end of the extension arm has a fifth mounting slot with a vent hole passing through it, and the Hall magnet is embedded and fixed in this slot.

Compared to existing technology, the beneficial effects of this invention include: The L-shaped sliding hole, consisting of a first and second sliding segment connected at an angle, helps prevent accidental activation. Additionally, the slider can be magnetically fixed in either the first or second sliding segment, effectively preventing accidental activation of the toggle lever and avoiding incorrect positioning of the Hall sensor and the first switch. This ensures the correct operation of the game controller, allowing accurate switching between the Hall linear feel and mechanical button feel, meeting various user requirements and demonstrating strong market competitiveness.

### BRIEF DESCRIPTION OF THE DRAWINGS

FIG. 1 is a front view of the first state of the invention;

FIG. 2 is a partial internal structure view after removing the bottom shell in the first state;

FIG. 3 is a partial internal structure view after removing the bottom shell and slider in the first state;

FIG. 4 is a structural view of the slider in the invention;

FIG. 5 is another view of the slider in the invention;

FIG. 6 is a structural view of the trigger button in the invention;

FIG. 7 is another view of the trigger button in the invention;

FIG. 8 is a perspective view of the bottom shell in the invention;

FIG. 9 is a partial assembly view of the bottom shell with the trigger button, slider, and first switch;

FIG. 10 is a front view of the first state of the invention;

FIG. 11 is an internal structure view after removing the bottom shell in the first state.

### DETAILED DESCRIPTION OF THE EMBODIMENTS

The present invention is further explained below in conjunction with specific embodiments and the accompanying drawings.

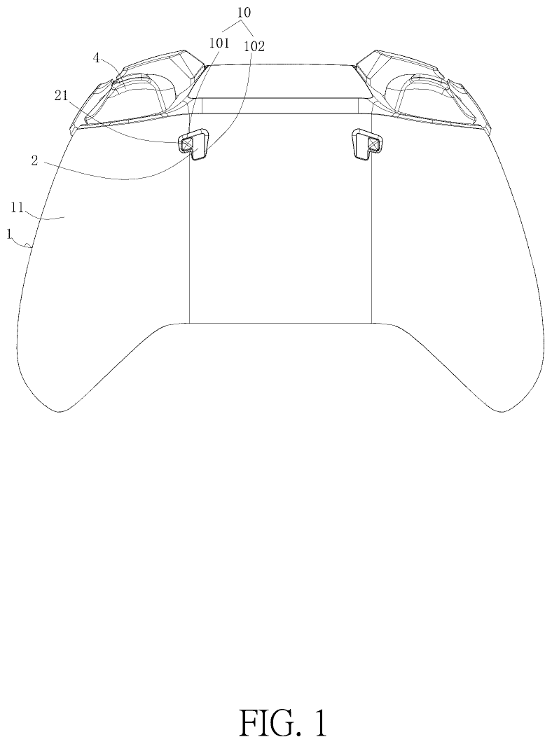

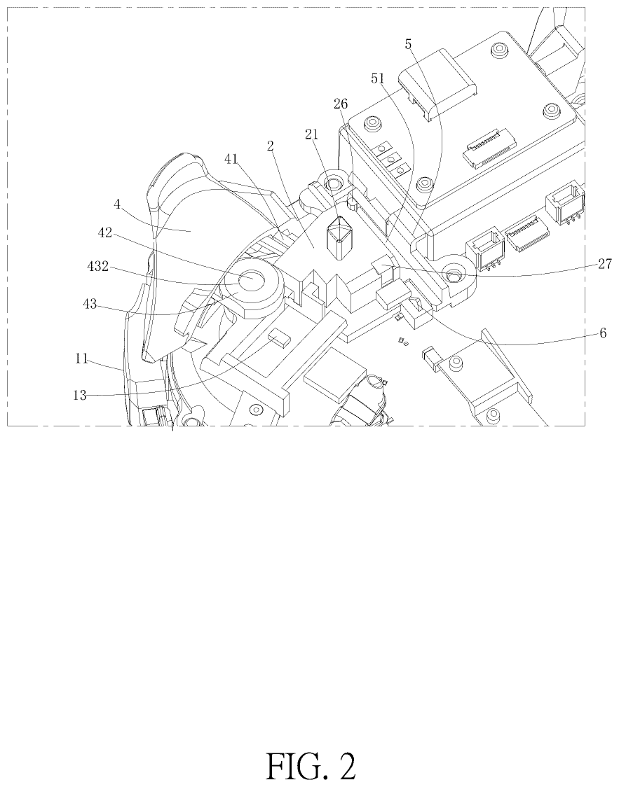

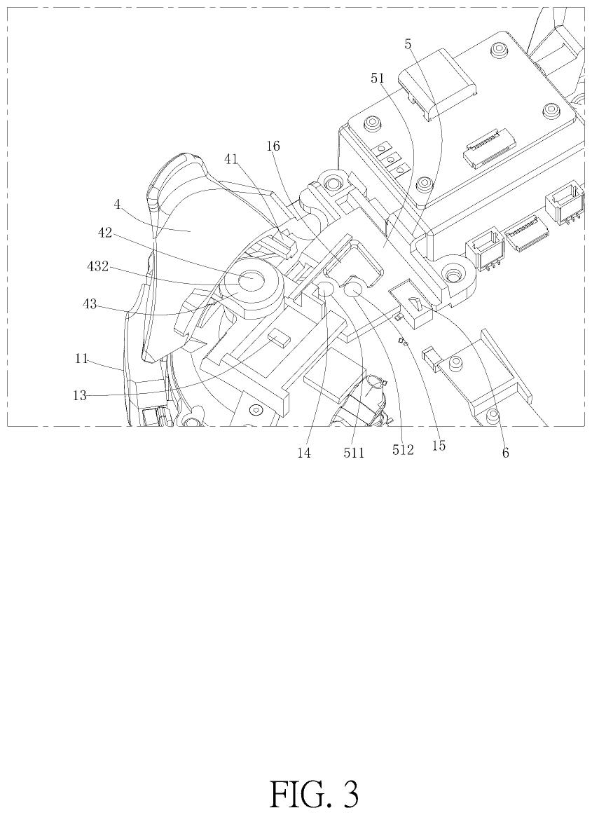

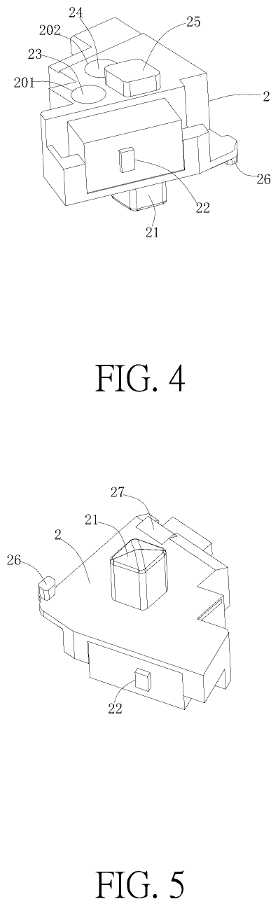

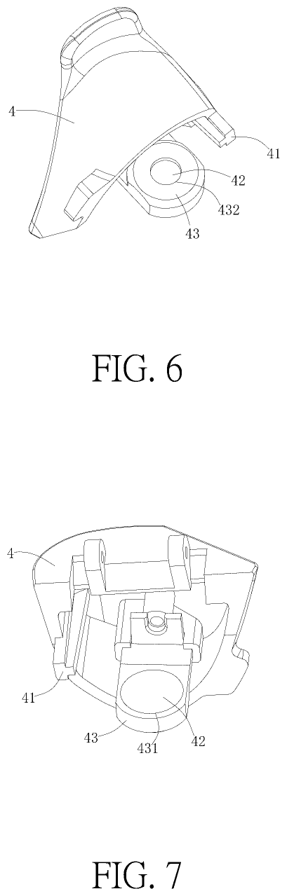

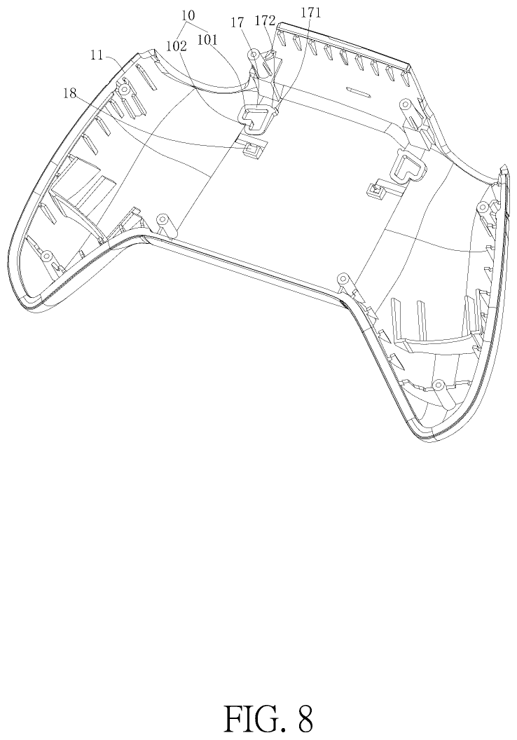

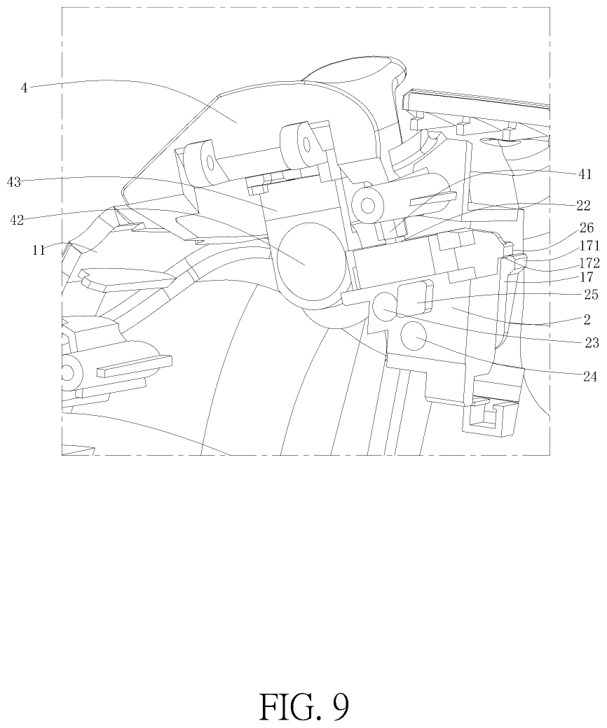

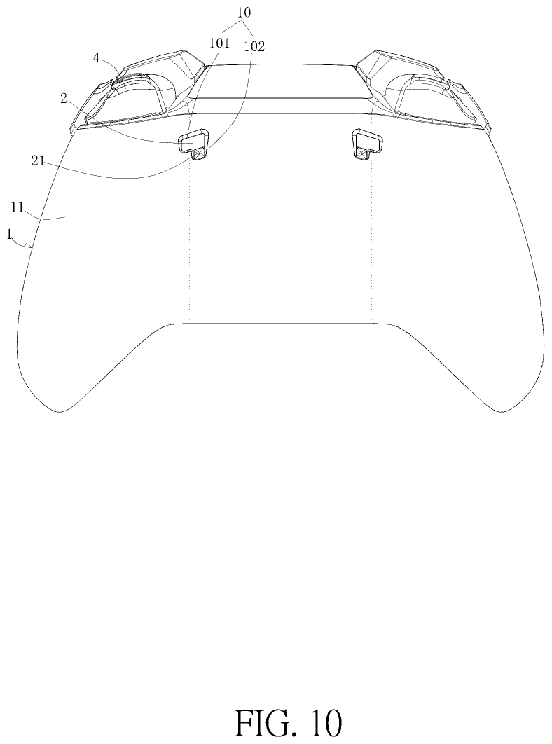

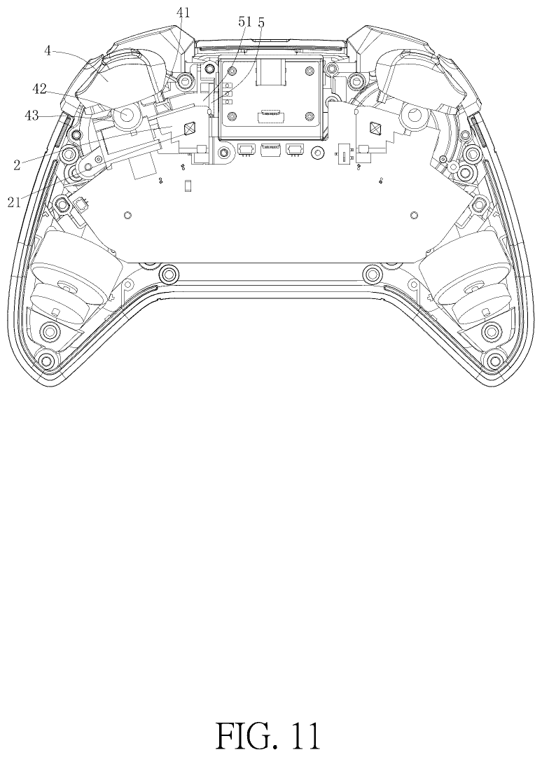

Referring to FIGS. 1-11, the invention is a two-stage switch structure for a game controller, which comprises a slider 2 located inside the controller casing 1 adjacent to the trigger button 4. The trigger button 4 is mounted on the controller casing 1 via an axle with a torsion spring. When the trigger button 4 is pressed, it can be depressed, compressing the torsion spring, which then provides an elastic restoring force upon release to return the trigger button 4 to its original position.

The controller casing 1 has a sliding hole 10 through which the toggle lever 21 of the slider 2 passes, extending outside the surface of the controller casing 1. The slider 2 is equipped with a first switch 22, and the trigger button 4 has a touch rod 41 that corresponds to the first switch 22. The controller casing 1 comprises a Hall sensor 13/Hall magnet, and the trigger button 4 comprises a Hall magnet 42/Hall sensor that matches the Hall sensor 13/Hall magnet. When the touch rod 41 contacts the first switch 22, pressing the trigger button 4 shortens the trigger button's travel distance, activating the first switch 22 and creating a mechanical button feel. When the toggle switch 6 is not triggered, the Hall sensor 13 is not activated. When the first switch 22 is distanced from the touch rod 41, sliding the slider 2 to activate the toggle switch 6 enables the Hall sensor 13. When the trigger button 4 is pressed, and the first switch 22 no longer blocks the touch rod 41, the Hall magnet activates the Hall sensor 13, creating a Hall linear feel. The toggle switch 6 is located next to the slider 2.

Specifically, the sliding hole 10 is L-shaped, consisting of a first sliding segment 101 and a second sliding segment 202 at an angle to each other. Inside the controller casing 1, there are a first magnet 14 and a second magnet 15. The slider 2 has a third magnet 23 and a fourth magnet 24 matching the first and second magnets, respectively. When the toggle lever 21 moves to the first sliding segment 101, the third magnet 23 and fourth magnet 24 are magnetically attracted to the first magnet 14 and second magnet 15, respectively, aligning the touch rod 41 with the first switch 22 and blocking the trigger button 4 from further depression, creating a short-travel mechanical feel. When the toggle lever 21 moves to the second sliding segment 202, the third magnet 23 is magnetically attracted to the second magnet 15, distancing the slider 2 from the touch rod 41, thereby triggering the toggle switch 6 to activate the Hall sensor 13. When the Hall sensor 13 is not activated, pressing the trigger button 4 allows the touch rod 41 to bypass the first switch 22, enabling the Hall magnet to activate the Hall sensor 13, creating a Hall linear feel and allowing for a longer travel distance.

In summary, by moving the toggle lever 21 to either the first sliding segment 101 or the second sliding segment 202 of the sliding hole 10, either the first switch 22 or the Hall sensor 13 is triggered, thus enabling the switch between the Hall linear feel and the mechanical button feel to meet different usage needs. Additionally, the L-shaped sliding hole 10 helps prevent accidental activation, as the toggle lever 21 requires a deliberate movement to switch between segments. The first and second magnets, along with the third and fourth magnets on the slider 2, help prevent accidental sliding of the toggle lever 21. When the toggle lever 21 moves to the second sliding segment 202, the third magnet 23 remains attracted to the second magnet 15, ensuring stable positioning of the slider 2.

The L-shaped sliding hole 10 is also suitable for narrow spaces.

To further ensure the stable positioning of the slider 2 after sliding, a fifth magnet 27 is added to the slider 2, and a sixth magnet 18 is positioned inside the controller casing 1 to match the fifth magnet 27. When the toggle lever 21 moves to the second sliding segment 202, the third magnet 23 and the second magnet 15 are magnetically attracted, as are the fifth magnet 27 and the sixth magnet 18, thus providing stable positioning of the slider 2 and preventing unintended movement of the toggle lever 21 due to minor external forces.

The first sliding segment 101 is inclined upward and vertically aligned, providing a certain amount of resistance, preventing the toggle lever 21 from accidentally sliding when lightly touched.

Additionally, the inner perimeter of the sliding hole 10 in the controller casing 1 forms a raised ring 17 with a blocking part 171 that comprises a concave arc groove 172. The slider 2 comprises a limiter 26 that fits into the arc groove 172 when the toggle lever 21 is in the first sliding segment 101, providing resistance and preventing unintended movement of the toggle lever 21. This mechanism ensures that the toggle lever 21 requires a deliberate push to leave the arc groove 172, thus avoiding accidental movement.

For enhanced stability of the slider 2 assembly, an L-shaped sliding groove 16 is provided inside the controller casing 1. The inner side of the slider 2 has a sliding part 25 positioned within the sliding groove 16, ensuring that the slider 2 is stably installed in the controller casing 1 while maintaining smooth movement.

The controller casing 1 comprises a bottom shell 11 and a top cover 12 fixed together, with the sliding hole 10 located on the bottom shell 11.

Both the cross-sections of the sliding part 25 and the toggle lever 21 are rectangular, allowing for stable assembly within the sliding groove 16 and the sliding hole 10, ensuring the stability of the entire slider 2 within the controller casing 1.

The end of the toggle lever 21 is either arc-shaped or pyramid-shaped, making it easier for the user to push and improving the feel of the toggle lever 21.

The inner side of the slider 2 comprises a third mounting slot 201 and a fourth mounting slot 202, embedding the third magnet 23 and the fourth magnet 24. To enhance stability, adhesive may be applied to the inner walls of the third and fourth mounting slots, ensuring that the magnets remain securely fixed in place.

A bracket 5 inside the controller casing 1 provides a mounting position 51 for the slider 2. The first magnet 14 and second magnet 15 are positioned in the first and second mounting slots 511 and 512 at the bottom of the mounting position 51. The inner side of the bracket 5 contains the sliding groove 16.

In this embodiment, the trigger button 4 comprises an extension arm 43 with a Hall magnet 42 at its end, and the controller casing 1 comprises a Hall sensor 13.

The inner end of the extension arm 43 comprises a fifth mounting slot 431 with a vent hole 432 passing through it, embedding and securing the Hall magnet 42 within this slot.

In conclusion, the L-shaped sliding hole 10, comprising a first and second sliding segment at an angle, helps prevent accidental activation. Additionally, the slider 2 remains magnetically positioned within the first or second sliding segment, preventing accidental activation of the toggle lever, thereby ensuring proper operation of the game controller. This invention enables accurate switching between the Hall linear feel and the mechanical button feel, meeting diverse user requirements and demonstrating strong market competitiveness.

Of course, the above description is merely a specific embodiment of the present invention and is not intended to limit its scope. Any equivalent modifications or variations made based on the construction, characteristics, and principles outlined in this patent application should be included within the scope of the invention.

I claim:

1. The two-stage switch structure for a game controller comprising:
a slider (2) positioned inside a controller casing (1) and adjacent to a trigger button (4), wherein the controller casing (1) is provided with a sliding hole (10), and a toggle lever (21) on the slider (2) passes through the sliding hole (10) to be exposed outside the surface of the controller casing (1);
the slider (2) is equipped with a first switch (22), and the trigger button (4) is provided with a touch rod (41) adapted to the first switch (22);
the controller casing (1) comprises a Hall sensor (13)/Hall magnet, and the trigger button (4) comprises a Hall magnet (42)/Hall sensor matching the Hall sensor (13)/Hall magnet;
the sliding hole (10) is L-shaped and comprises a first sliding segment (101) and a second sliding segment (202) connected at an angle, with a first magnet (14) and a second magnet (15) positioned inside the controller casing (1);
the slider (2) is equipped with a third magnet (23) and a fourth magnet (24) adapted to the first magnet (14) and the second magnet (15), respectively;
when the toggle lever (21) slides to the first sliding segment (101), the third magnet (23) and fourth magnet (24) are magnetically attracted to the first magnet (14) and second magnet (15), respectively, aligning the touch rod (41) with the first switch (22) and blocking the trigger button (4);
when the toggle lever (21) slides to the second sliding segment (202), the third magnet (23) is magnetically attracted to the second magnet (15), distancing the slider (2) from the touch rod (41) and triggering a toggle switch (6) to activate the Hall sensor (13);
wherein pressing the trigger button (4) then causes the Hall magnet

(42) to activate the Hall sensor (13).

2. The two-stage switch structure for the game controller according to claim 1, wherein the first sliding segment (101) is inclined upward; the first sliding segment (101) is vertically aligned; the slider (2) further comprises a fifth magnet (27), and the controller casing (1) further comprises a sixth magnet (18) matching the fifth magnet (27), wherein when the toggle lever (21) slides to the second sliding segment (202), the third magnet (23) and the second magnet (15) are magnetically attracted, as are the fifth magnet (27) and the sixth magnet (18).

3. The two-stage switch structure for a game controller according to claim 2, wherein an L-shaped sliding groove (16) is positioned inside the controller casing (1), and the inner side of the slider (2) comprises a sliding part (25) that fits into the sliding groove (16).

4. The two-stage switch structure for the game controller according to claim 3, wherein the controller casing (1) comprises a bottom shell (11) and a top cover (12) fixed together, with the sliding hole (10) positioned on the bottom shell (11).

5. The two-stage switch structure for the game controller according to claim 3, wherein both the sliding part (25) and the toggle lever (21) have rectangular cross-sections.

6. The two-stage switch structure for the game controller according to claim 1, wherein the end of the toggle lever (21) is arc-shaped or pyramid-shaped;
the inner side of the slider (2) comprises a third mounting slot (201) and a fourth mounting slot (202), with the third magnet (23) and fourth magnet (24) embedded in the third mounting slot (201) and fourth mounting slot (202), respectively.

7. The two-stage switch structure for the game controller according to claim 1, wherein the inner perimeter of the sliding hole (10) in the controller casing (1) comprises a raised ring (17), the outer side of the raised ring (17) has a blocking part (171) with a concave arc groove (172); the slider (2) comprises a limiter (26) that fits into the concave arc groove (172) when the toggle lever (21) slides to the first sliding segment (101).

8. The two-stage switch structure for the game controller according to claim 1, wherein the controller casing (1) comprises a bracket (5), the bracket (5) provides a mounting position (51) for the slider (2) to slide, and the first magnet (14) and second magnet (15) are positioned in a first mounting slot (511) and a second mounting slot (512) at the bottom of the mounting position (51), with the sliding groove (16) located on the inner side of the bracket (5).

9. The two-stage switch structure for the game controller according to claim 1, wherein the trigger button (4) comprises an extension arm (43), with a Hall magnet (42) positioned at the end of the extension arm (43), and a Hall sensor (13) positioned inside the controller casing (1).

10. The two-stage switch structure for the game controller according to claim 9, wherein the inner end of the extension arm (43) comprises a fifth mounting slot (431) with a vent hole (432) passing through it, and the Hall magnet (42) is embedded and fixed in the fifth mounting slot (431).
